(19) United States
(12) Patent Application Publication
(10) Pub. No.: US 2011/0254266 A1
(43) Pub. Date: Oct. 20, 2011

(54) Self-restraining system for belled pipe

(75) Inventors: Samuel Guzowski, San Jose (CR); Miguel Gomez, San Jose (CR); Claudio Dittel, San Jose (CR)

(73) Assignee: Max Seal, Inc., San Diego, CA (US)

(21) Appl. No.: 12/799,102

(22) Filed: Apr. 19, 2010

(51) Int. Cl. F16L 21/02

(52) U.S. Cl. 285/374

(57) ABSTRACT

A restrainer for connection to the belled end of a female pipe or fitting. The restrainer has a groove for receiving a compressed, snap-fit gripping ring, constructed from two or more rigid segments joined by elastomeric segments. The gripping ring has rows of teeth on its inner circumference, shaped so the spigot end of a male pipe can be inserted through the restrainer into the belled end of the female pipe. The gripping ring restrains the male pipe from moving in an opposite direction when the system is pressurized. The coupler can be connected to the female pipe in several ways: it can be threaded onto a threaded lip of the pipe; a projection formed on its outer diameter or its inner diameter can be snap-fit into on onto the end of the female pipe; or it can be welded or fused onto the outer end of the female pipe.

### FIELD OF THE INVENTION

The present invention relates to a self-restraining system for connecting the belled end of a length of pipe to the spigot end of a length of pipe or fitting.

### BACKGROUND OF THE INVENTION

Pipelines for conveying fluids can be made from a number of different materials, including plastic materials, such as polyvinyl chloride (PVC), and metals, such as steel, brass and aluminum. Each length of such pipe typically has a belled female end and a spigot male end. The joints between sections of pipe are sealed, typically with a gasket. In addition, some type of restraining system is required in order to prevent separation of the sections of pipe due to fluid pressures and environmental effects. External restraining systems are expensive and require time-consuming installation procedures. Development of self-restraining systems using gaskets initially emulated systems used in the ductile iron industry to join sections of iron pipe. For example, systems for joining ductile iron fittings to PVC pipe, such as those shown in U.S. Pat. Nos. 6,945,570 and 7,125,054, use bolted flanges along with the gasket.

Some systems have been developed for connecting sections of PVC pipe and for connecting fittings to PVC pipe. These PVC pipe systems have relied mainly on the “Rieber Joint,” which was developed in the early 1970's by Rieber & Son of Bergen, Norway, to seal the connections. The Rieber Joint has an elastomeric gasket inserted into a groove on the inside of the belled end of a piece of the PVC pipe as the female end is being formed. Elements are then added to restrain the pipe after the joint is assembled. For instance, in U.S. Pat. No. 7,284,310, the restraint mechanism, which is integral to the bell, is a ring-shaped gripping insert having gripping teeth and a circumferential slit; it is compressed and snapped into the circumferential region of a ring-shaped housing inside the belled end. When the spigot end is inserted and the joint is pressurized, the gripping insert is activated.

While such a system is an improvement over simply using the Rieber Joint and an external restraining system, it has several disadvantages, including the possibility of failure. A need exists for a self-restraining system for bell and spigot pipes and fittings, made from a variety of materials, which is easy to install and unlikely to fail, and which can be used in both types of joints, with both integrated and non-integrated gaskets.

### SUMMARY OF THE INVENTION

The present invention is used to join sections of pipe from normal production runs. As is still a current practice, a gasket is placed into a previously-formed groove inside the female end of a piece of pipe; when an integrated gasket is used, the groove is formed around the gasket, as in the Rieber Joint system. A restrainer with a coupler is then installed on or inside the front lip of the bell, using one of several methods described herein. A gripping ring, which is constructed from two or more rigid segments joined by elastomeric segments, is compressed and snapped into a groove formed on the inside of the restrainer. Rows of teeth formed on the inner circumference of the gripping ring are shaped to allow the spigot end of a male pipe to be inserted through the restrainer into the belled end of the female pipe or fitting, in order to restrain the male pipe from moving in an opposite direction when the system is pressurized or when other external forces act on the joint. The result is a self-restraining joint.

Several different embodiments of the restrainer, its coupler, and the gripping ring are described herein. Each operates in a similar manner to create a self-restraining joint.

One type of restrainer has a coupler that is threaded onto the threaded lip of the belled pipe or fitting, while another has a coupler that is snap-fit onto the lip. A coupler can also be joined by spin welding, solvent welding or another method. The gripping ring has two or more segments of rigid material joined by segments of elastomeric material. It can have a layer of elastomeric material around its outer circumference, or it can be constructed without such a layer.

It is an object of the present invention to provide a system which can convert any connection between sections of bell and spigot pipe and/or tee-shaped or ell-shaped fittings into a restrained joint.

Another object of the present invention is to include a restrainer that reinforces the belled end of a female pipe and enhances its performance under high deflection and other extreme conditions.

A further object of the present invention is to provide a flexible gripping ring for insertion into the restrainer, the elastomeric material of the gripping ring compensating for variances in the outer diameter of the spigot pipe and ensuring that the restraining mechanism is distributed around the pipe.

Yet another object of the present invention is to provide a restrainer that can be shaped to make the pipe joint smoother for trenchless applications.

A still further object of the present invention is to provide a restrainer and a gripping ring that are made of corrosion-resistant materials.

### BRIEF DESCRIPTION OF THE DRAWINGS

FIG. 1 is a perspective partial-sectional view of the system of the present invention, showing the coupler of the restrainer threaded onto the front lip of the belled end of a pipe, with the gripping ring in place.

FIG. 2 is a side sectional view of the gripping ring, the threaded restrainer into which the gripping ring will be inserted, and the threads on the lip of the belled end of the pipe onto which the restrainer will be threaded.

FIG. 3 is a view of the gripping ring, taken along lines 3-3 of FIG. 2.

FIG. 4 is a detail view showing the threads and groove formed on the inner circumference of the restrainer.

FIG. 5 is a sectional view of the assembled self-restraining joint of the present invention, showing the spigot end of the male pipe inside the restrainer and belled end of the female pipe, with the gripping ring restraining the spigot end.

FIG. 6 is a sectional view of the assembled joint taken along lines 6-6 of FIG. 5.

FIGS. 7A and 7B show the movement of the spigot end of the male pipe into the restrainer and female pipe, the compression of the gripping ring, and the restraining of the male pipe inside the female pipe, with the seal created by the integrated gasket.

FIG. 8 shows an alternate embodiment of the restrainer, which is installed by snap-fitting a projection on the coupler of the restrainer into a channel in the inner diameter of the lip of the belled end of the female pipe.

FIG. 9 shows an alternate embodiment of the restrainer, which is installed by snap-fitting a projection on the coupler of the restrainer into a channel in the outer diameter of the lip of the belled end of the female pipe.

FIG. 10 is a plan view of another alternate embodiment of the restrainer, which is fabricated from two half-circular pieces, which are bolted together around the lip of a female pipe.

FIG. 11 is a cross-sectional view of the alternate embodiment of the restrainer shown in FIG. 10, after it has been mounted onto the outer surface of the lip of the belled end of the female pipe.

FIG. 12 is a cross-sectional view of yet another alternate embodiment of the restrainer, which has been welded or fused onto the outer surface of the lip of the belled end of a female pipe.

### DESCRIPTION OF PREFERRED EMBODIMENTS

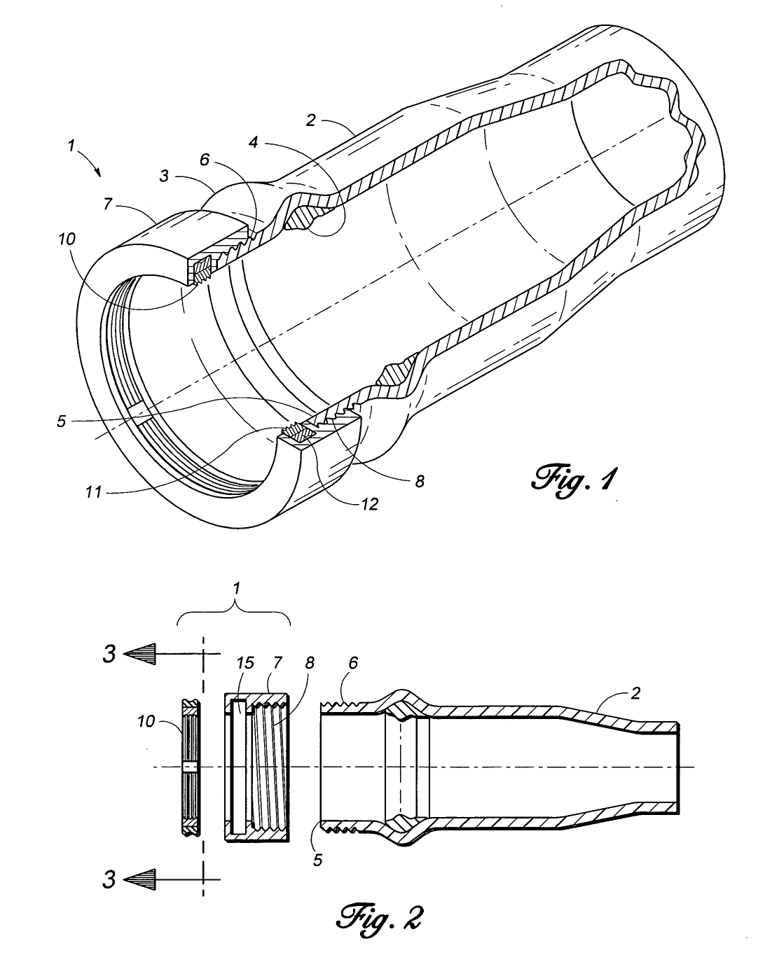

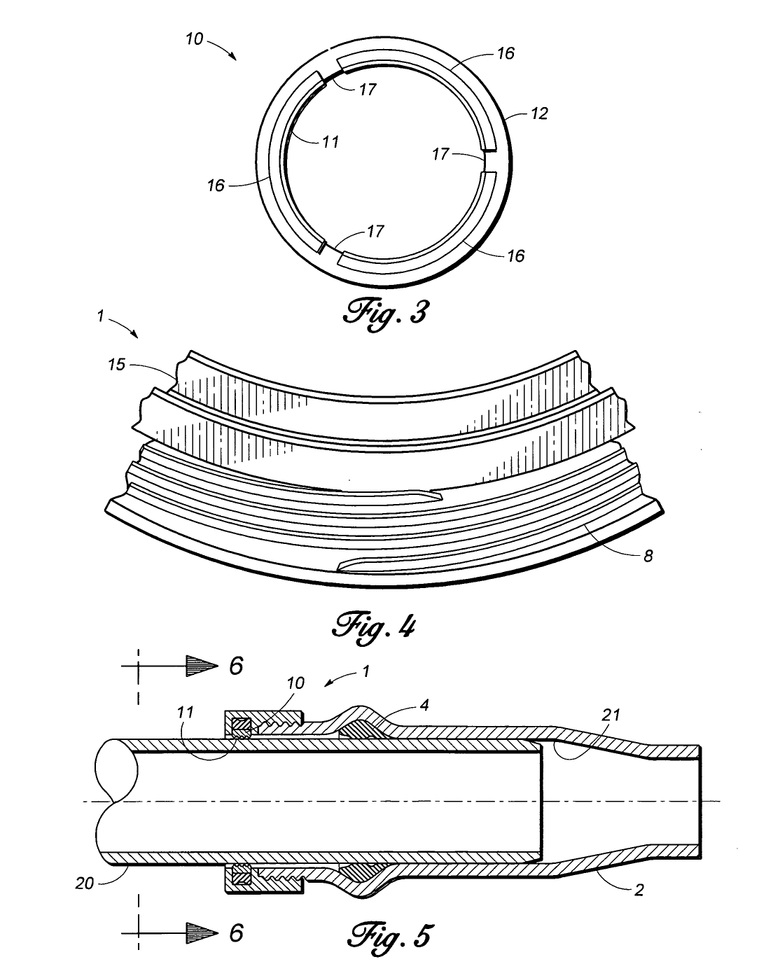

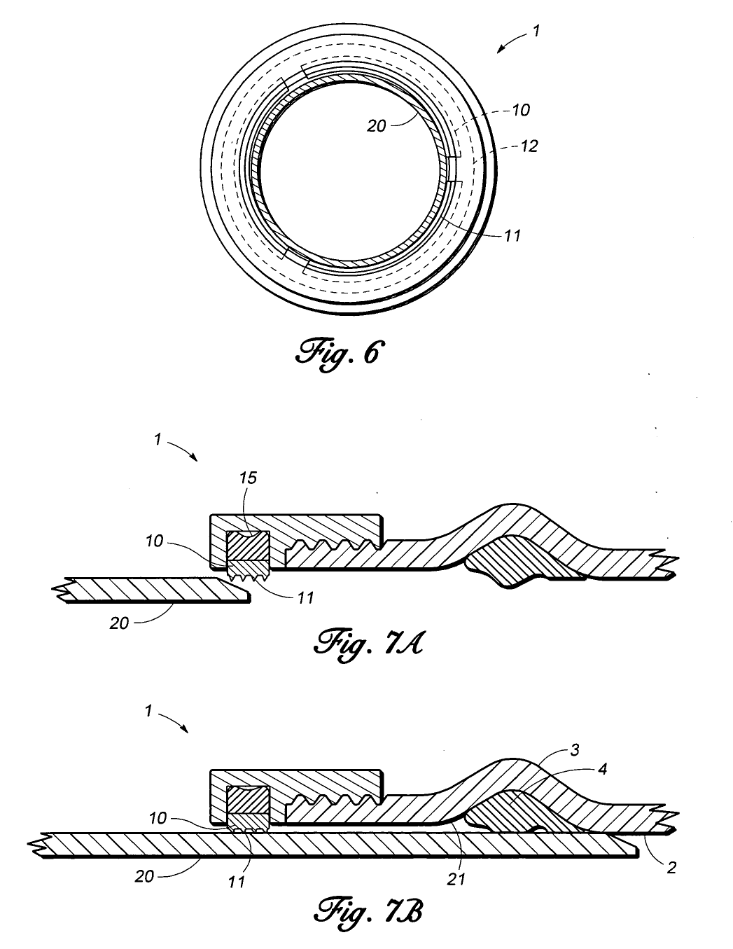

As shown in FIG. 1, the restrainer 1 of the present invention has been fabricated for use with a female pipe 2, which has a bell 3 with an integrated or other type of gasket 4, which will seal the joint. The outer diameter of the lip 5 of the belled pipe 2 has had threads 6 inscribed thereon. A leading portion of the inner diameter of the coupler 7 of the restrainer 1 has complementary threads 8 formed thereon for affixing the restrainer 1 to the female pipe 2. The coupler 7 can be made from any of a number of materials, including steel with a corrosion-protection coating, stainless steel, brass, aluminum, polyvinyl chloride (PVC) or other rigid plastic material, or a composite material. Installed in the coupler 1 is a gripping ring 10 for restraining a male pipe (not shown). The gripping ring 10 has rows of gripping teeth 11 formed on its inner circumference. An elastomeric layer 12 around the outer circumference of the gripping ring 10 will compensate for any variances in the outer circumference of a male pipe (not shown) when inserted in the restrainer 1.

FIG. 2 shows the gripping ring 10 before it is inserted into the receiving groove 15 in the bore of the coupler 7. The threads 8 on the inner diameter of the coupler 7 of the restrainer 1 can be more clearly seen, as can the threads 6 formed on the lip 5 of the belled pipe 2. The restrainer 1 will be threaded onto the lip 5 of the belled pipe 2.

As shown in FIG. 3, the gripping ring 10 is formed with two or more rigid segments 16, which are typically made from a rigid material such as plain steel with corrosion-protection coating, stainless steel, brass, aluminum, or a material such as ceramic. Elastomeric segments 17 join the gripping ring segments 16 to form a circle, and the same elastomeric material is molded to form a layer 12 around the outer circumference of the gripping ring segments 16. The elastomeric material used, which can be rubber or a thermoplastic elastomer, allows the gripping ring 10 to be compressed so it can be snap-fit into the receiving groove 15. It also will compensate for any variances in the circumference of the spigot pipe 20 during assembly of the joint. Additionally, it causes the rows of teeth 11 on the inner circumference of the gripping ring 10 to press against the spigot pipe 20 after the joint is pressurized.

FIG. 4 shows the threads 8 on the coupler 7 of the restrainer 1, along with the groove 15 for receiving the gripping ring 10.

FIG. 5 shows the assembled self-restraining joint using the restrainer 1 of the present invention. A male spigot pipe 20 has been inserted through the restrainer 1 into the bore 21 of the female pipe 2. The gasket 4 creates a seal for the joint. The rows of teeth 11 on the gripping ring 10 press against the outer circumference of male pipe 20, restraining it from longitudinal movement away from the female pipe 2 after the joint is pressurized. The restrainer 1 of the present invention can also be used to join sections of PVC pipe to fabricated and molded plastic fittings. Alternatively, the female pipe 2 and male spigot pipe 20 with which the restrainer 1 is used, as well as pipe fittings, can be made from ductile iron, steel, and other rigid materials.

FIG. 6 shows the male pipe 20 inside the restrainer 1 of the present invention, with the elastomeric layer 12 around the gripping ring 10 and the teeth 11 pressing against the spigot pipe 20.

FIG. 7A shows a sectional view of the movement of the spigot pipe 20 into the restrainer 1 of the present invention. The spigot pipe 20 is able to move past the rows of teeth 11 on the gripping ring 10 inside the receiving groove 15 in the restrainer 1.

As shown in FIG. 7B, the spigot pipe 20 has traveled through the restrainer 1 and through the bore 21 past the bell 3 of the female pipe 2. The gasket 4 creates a seal for the joint. The rows of teeth 11 on the gripping ring 10 press against the outer circumference of the male pipe 20, restraining it from longitudinal movement away from the female pipe 2 after the joint is pressurized.

Alternative mechanisms can be devised in order to couple the restrainer of the present invention to the lip 5 of a female pipe 2. Several other mechanical joining methods are possible, including the ones described infra.

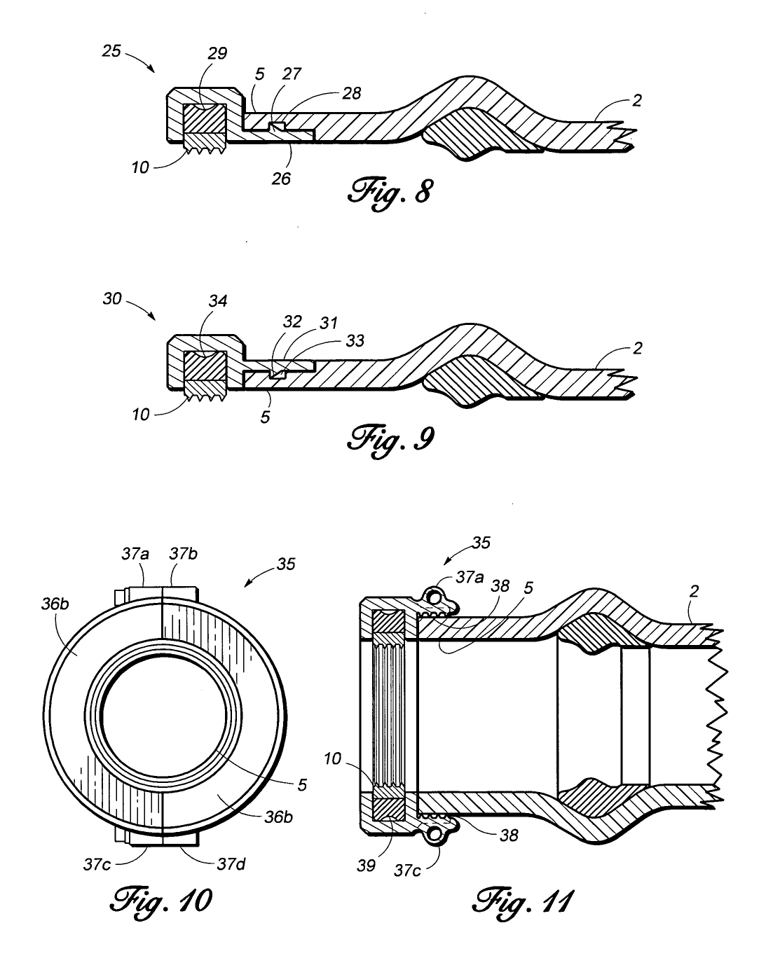

FIG. 8 shows a “snap-in” restrainer 25, having a coupler 26 with a circular projection 27 formed on its outer diameter. The lip 5 of the female pipe 2 has been inscribed with one or more circular channels 28 around its inner circumference. The restrainer 25 is installed onto the female pipe 2 by snap fitting the projection 27 on the coupler 26 into a channel 28 inscribed inside the lip 5 of the female pipe 2. The gripping ring 10, which has been snap-fit into groove 29, is the same as the one described in FIGS. 1 through 7, supra.

FIG. 9 shows a “snap-on” restrainer 30, having a coupler 31 with a circular projection 32 formed on its inner diameter. The lip 5 of the female pipe 2 has been inscribed with one or more circular channels 33 around its outer circumference. The restrainer 30 is installed onto the female pipe 2 by snap fitting the projection 32 on the coupler 31 into a channel 33 on the outside of the lip 5 of the female pipe 2. The gripping ring 10, which has been snap-fit into groove 34, is the same as the one described in FIGS. 1 through 7, supra.

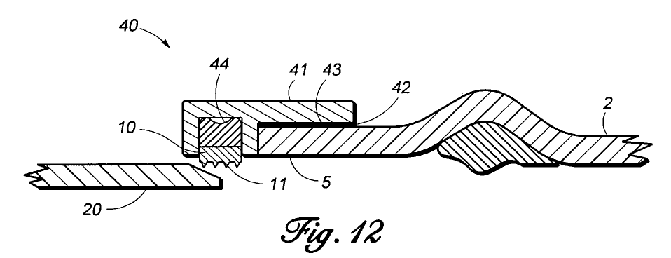

The restrainer 35 shown in FIG. 10 comprises two half-circular pieces 36a, 36b, which have been bolted together with bolts (not shown) through flanges 37a, 37b, 37c, 37d to enclose the lip 5 of a female pipe.

The cross-sectional view in FIG. 11 shows more clearly how the restrainer 35 is mounted onto the lip 5 of the belled end of female pipe 2. Restraining teeth 38 on the inner diameter of flanges 37a, 37c (37b, 37d) help hold the restrainer 35 onto the lip 5 of the female pipe 2. The gripping ring 10, which has been snap-fit into groove 39, is the same as the one described in FIGS. 1 through 7, supra.

Another embodiment is shown in FIG. 12. The restrainer 40, has a coupler 41 with an inner bore 42. When the restrainer 40 will be used with plastic pipe, the coupler 41 is fabricated from a rigid plastic such as polyvinyl chloride (PVC), ceramic, composite, or a similar material. The leading portion of the coupler 41 has been fused or solvent welded onto the outer diameter of the lip 5 of a female pipe 2 at mated surfaces 43. When the restrainer 40 will be used with metal pipe, the coupler 41 is fabricated from a material such as steel with a corrosion-protection coating, stainless steel, brass, or aluminum. The leading portion of such a coupler 41 is welded onto the outer diameter of the lip 5 of a female pipe 2 at mated surfaces 43. In either event, the gripping ring 10, which has been snap-fit into groove 44, is the same as the one described in FIGS. 1 through 7, supra. After the spigot pipe 20 has been inserted into the bore 21 of the female pipe 2, the joint will be pressurized, causing the rows of teeth 11 on the inner circumference of the gripping ring 10 to press against the spigot pipe 20.

The information in the disclosure and description of the invention itself are illustrative only of the application of the principles of the present invention. For example, the restrainer described herein can be installed onto the ends of pipe fittings in the same manner as described for its installation onto the ends of lengths of female pipe. Other modifications and alternative embodiments may be devised by those skilled in the art without departing from the spirit and scope of the present invention.

We claim:

1. A restrainer for joining an end of a male spigot pipe to an end of a female pipe having a bell, the female pipe having a gasket disposed inside the bell, the end of the female pipe further having a lip surface with threads inscribed thereon, the restrainer comprising:
(1) a cylindrical coupler having a bore with a first portion having threads complementary to the threads on the lip surface of the end of the female pipe and a second portion having a recessed groove; and
(2) a gripping ring comprising at least two metal segments having inner diameters and outer diameters, the metal segments spaced apart and connected with segments of elastomeric material, and further having a layer of elastomeric material encircling the outer diameters of the metal segments, the inner diameters of the metal segments having at least two rows of circumferential teeth, the gripping ring being compressed and snap-fit into the recessed groove in the coupler;
the restrainer being used to form a pipe joint by threading the first portion of the coupler onto the threads on the lip surface of the end of the female pipe and then inserting the end of the male spigot pipe into and through the bore of the restrainer and into the female pipe, the joint then being pressurized, causing the rows of teeth on the inner diameters of the metal segments to press against the male spigot pipe, restraining it from longitudinal movement away from the female pipe.

2. The restrainer of claim 1, wherein the coupler is made from a material selected from the group consisting of steel with a corrosion-protection coating, stainless steel, brass, aluminum, and a rigid plastic such as polyvinyl chloride (PVC).

3. The restrainer of claim 1 wherein the segments of elastomeric material and layer of elastomeric material in the gripping ring are made from rubber or a thermoplastic material.

4. A restrainer for joining an end of a male spigot pipe to an end of a female pipe having a bell and an inner circumference, the female pipe having a gasket disposed inside the bell, the female pipe further having a lip with a circular channel formed in the inner circumference of the lip, the restrainer comprising:
(1) a cylindrical coupler with a bore, the coupler having a first portion with an outer surface having a circular projection formed thereon, the projection being complementary to the circular channel formed in the inner circumference of the lip at the end of the female pipe, the bore of the coupler further having a recessed groove; and
(2) a gripping ring comprising at least two metal segments having inner diameters and outer diameters, the metal segments spaced apart and connected with segments of elastomeric material, and further having a layer of elastomeric material encircling the outer diameters of the metal segments, the inner diameters of the metal segments having at least two rows of circumferential teeth, the gripping ring being compressed and snap-fit into the recessed groove in the coupler;
the restrainer being used to form a pipe joint by snap fitting the first portion of the coupler into the channel inscribed inside the lip at the end of the female pipe and then inserting the end of the male spigot pipe into and through the bore of the restrainer and into the female pipe, the joint then being pressurized, causing the rows of teeth on the inner diameters of the metal segments to press against the male spigot pipe, restraining it from longitudinal movement away from the female pipe.

5. The restrainer of claim 4, wherein the coupler is made from a material selected from the group consisting of steel with a corrosion-protection coating, stainless steel, brass, aluminum, and a rigid plastic such as polyvinyl chloride (PVC).

6. The restrainer of claim 4 wherein the segments of elastomeric material and layer of elastomeric material in the gripping ring are made from rubber or a thermoplastic material.

7. A restrainer for joining an end of a male spigot pipe to an end of a female pipe having a bell and an outer circumference, the female pipe having a gasket disposed inside the bell, the female pipe further having a lip with a circular channel formed on the outer circumference of the lip, the restrainer comprising:
(1) a cylindrical coupler with a bore, the coupler having a first portion with an inner surface having a circular projection formed thereon, the projection being complementary to the circular channel formed in the outer circumference of the lip at the end of the female pipe, the bore of the coupler further having a recessed groove; and
(2) a gripping ring comprising, at least two metal segments having inner diameters and outer diameters, the metal segments spaced apart and connected with segments of elastomeric material, and further having a layer of elastomeric material encircling the outer diameters of the metal segments, the inner diameters of the metal segments having at least two rows of circumferential teeth, the gripping ring being compressed and snap-fit into the recessed groove in the coupler;
the restrainer being used to form a pipe joint by snap fitting the first portion of the coupler into the channel inscribed on the outer circumference of the lip at the end of the female pipe and then inserting the end of the male spigot pipe into and through the bore of the restrainer and into the female pipe, the joint then being pressurized, causing the rows of teeth on the inner diameters of the metal segments to press against the male spigot pipe, restraining it from longitudinal movement away from the female pipe.

8. The restrainer of claim 7, wherein the coupler is made from a material selected from the group consisting of steel with a corrosion-protection coating, stainless steel, brass, aluminum, and a rigid plastic such as polyvinyl chloride (PVC).

9. The restrainer of claim 7 wherein the segments of elastomeric material and layer of elastomeric material in the gripping ring are made from rubber or a thermoplastic material.

10. A restrainer for joining an end of a male spigot pipe to an end of a female pipe having a bell and an outer circumference, the female pipe having a gasket disposed inside the bell, the female pipe further having a lip, the restrainer comprising:
(1) a cylindrical coupler formed by joining two complementary half-circular sections having flanges for receiving bolts, the coupler having a bore with a recessed groove; and
(2) a gripping ring comprising at least two metal segments having inner diameters and outer diameters, the metal segments spaced apart and connected with segments of elastomeric material, and further having a layer of elastomeric material encircling the outer diameters of the metal segments, the inner diameters of the metal segments having at least two rows of circumferential teeth, the gripping ring being compressed and snap-fit into the recessed groove in the coupler;
the restrainer being used to form a pipe joint by fitting the flanges on the sections of the coupler over the lip at the end of the female pipe and then bolting the sections together and then inserting the end of the male spigot pipe into and through the bore of the restrainer and into the female pipe, the joint then being pressurized, causing the rows of teeth on the inner diameters of the metal segments to press against the male spigot pipe, restraining it from longitudinal movement away from the female pipe.

11. The restrainer of claim 10, wherein the coupler is made from a material selected from the group consisting of steel with a corrosion-protection coating, stainless steel, brass, aluminum, and a rigid plastic such as polyvinyl chloride (PVC).

12. The restrainer of claim 10 wherein the segments of elastomeric material and layer of elastomeric material in the gripping ring are made from rubber or a thermoplastic material.

13. A restrainer for joining an end of a male spigot pipe to an end of a female pipe having a bell, the female pipe having a gasket disposed inside the bell, the end of the female pipe further having a lip surface having an outer diameter, the restrainer comprising:
(1) a cylindrical coupler having a bore and a leading portion, the leading portion sized to fit over the outer diameter of the lip surface on the end of the female pipe, the coupler further having a second portion having a recessed groove; and
(2) a gripping ring comprising at least two metal segments having inner diameters and outer diameters, the metal segments spaced apart and connected with segments of elastomeric material, and further having a layer of elastomeric material encircling the outer diameters of the metal segments, the inner diameters of the metal segments having at least two rows of circumferential teeth, the gripping ring being compressed and snap-fit into the recessed groove in the coupler;
the leading portion of the coupler being affixed to the outer diameter of the lip surface on the end of the female pipe, the end of the male spigot pipe then being inserted into and through the bore of the restrainer and into the female pipe, the joint then being pressurized, causing the rows of teeth on the inner diameters of the metal segments to press against the male spigot pipe, restraining it from longitudinal movement away from the female pipe.

14. The restrainer of claim 13 wherein the segments of elastomeric material and layer of elastomeric material in the gripping ring are made from rubber or a thermoplastic material.

15. The restrainer of claim 13, wherein the coupler is made from a material selected from the group consisting of ceramic, composite, and a rigid plastic such as polyvinyl chloride (PVC).

16. The restrainer of claim 15 wherein the leading portion of the coupler is affixed to the outer diameter of the lip surface on the end of the female pipe by fusing or solvent welding.

17. The restrainer of claim 13, wherein the coupler is made from a material selected from the group consisting of steel with a corrosion-protection coating, stainless steel, brass, aluminum.

18. The restrainer of claim 15 wherein the leading portion of the coupler is affixed to the outer diameter of the lip surface on the end of the female pipe by welding.
